(19) United States
(12) Patent Application Publication
(10) Pub. No.: US 2023/0132465 A1
(43) Pub. Date: May 4, 2023

(54) AUTOMATED SKILL DISCOVERY, SKILL LEVEL COMPUTATION, AND INTELLIGENT MATCHING USING GENERATED HIERARCHICAL SKILL PATHS

(71) Applicant: BMC Software, Inc., Houston, TX (US)

(72) Inventors: Ajoy Kumar, Santa Clara, CA (US); Priya Saurabh Talwalkar, Pune (IN); Mantinder Jit Singh, Vancouver (CA)

(21) Appl. No.: 17/452,998

(22) Filed: Oct. 31, 2021

(51) Int. Cl. G06Q 10/06; G06N 5/02; G06Q 10/10

(52) U.S. Cl. CPC G06Q 10/063112; G06Q 10/06398; G06N 5/022; G06Q 10/105

(57) ABSTRACT

A system, method, and computer program product for intelligent-skills-matching includes receiving a plurality of tickets, where each ticket in the plurality of tickets includes a plurality of fields and at least one agent who resolved the ticket is identified. A clustering algorithm is used on one or more of the plurality of fields to determine skills from the plurality of tickets. A taxonomy of the skills is generated using a taxonomy-construction algorithm. Using the taxonomy of the skills, a skills matrix or a skills knowledge graph is created with agents assigned to the skills.

### TECHNICAL FIELD

This description relates to automated skill discovery, skill level computation, and intelligent matching using generated hierarchical skill paths.

### BACKGROUND

Knowing agent skills in service management can help in many information technology service management (ITSM) service desk processes such as routing tickets or routing cases to the right “skilled” agents, which, in turn, can reduce the mean time to repair (MTTR) and improve customer satisfaction. However, agent skills are rarely used in managing service desk processes because determining and knowing agent skills is a complicated, time-consuming activity involving many variables making it almost impossible for humans to manage.

Questions arise regarding an agent's depth and proficiency in a particular skill. For example, some agents have a higher proficiency and more skill in handling and resolving “Mac desktop issues” than other agents and should have such issues routed to them. Similarly, Windows desktop tickets should be re-routed to an agent skilled in “Windows desktop issues.” An agent's depth and proficiency in particular skills need to be evaluated and tracked so that more “complex” tickets are routed to those agents with a higher skill level in that subject area.

Furthermore, manual-skills management is error-prone and inaccurate due to the fact that agents' skills are dynamic and can evolve over time. Due to these challenges, skills that are manually curated and maintained rarely work well in practice. And yet, knowing agents' skills across an organization can benefit both the organization and the agent. For example, knowing agents' skills can help create organizational and individual training plans. During major ITSM incidents, knowing agent skills can help in swarming where the right team members with appropriate skills are needed for collaborating to solve widely impacting issues. The organization needs to identify skills gaps and areas where an agent or agents would benefit from additional training and to identify areas where an organization is lacking skilled agents. Identifying agents with sufficient skills to author knowledge articles on certain topics helps the organization preserve accumulated knowledge on such topics for the benefit of other less skilled agents. The agent benefits in that the agent's level of skill can be enhanced when greater skill challenges are presented to the agent as experience is built. The organization benefits by having more satisfied employees resulting in a greater possibility of retaining experienced agents.

### SUMMARY

According to one general aspect, a computer-implemented method for intelligent-skills-matching includes receiving a plurality of tickets, where each ticket in the plurality of tickets includes a plurality of fields and at least one agent who resolved the ticket is identified. A clustering algorithm is used on one or more of the plurality of fields to determine skills from the plurality of tickets. A taxonomy of the skills is generated using a taxonomy-construction algorithm. Using the taxonomy of the skills, a skills matrix or a skills knowledge graph is created with agents assigned to the skills.

Implementations may include one or more of the following features. For example, the computer-implemented method may further include computing a skills score for each agent and a related skill, and updating the skills matrix or the skills knowledge graph with the skills score. The computer-implemented method may further include receiving a new ticket, determining skills needed to resolve the new ticket, using a search engine to search for the determined skills in the skills matrix, or in the skills knowledge graph and to search for an agent with a high skills score for the determined skills, and automatically routing the new ticket to the agent with the high skills score for the determined skills. The computer-implemented method may further include, in response to the agent completing the new ticket, re-computing the skills score for the agent and the determined skills and updating the skills matrix of the skills knowledge graph with the re-computed skills score.

In some implementations, determining the skills includes determining static skills from category fields from the plurality of fields.

In some implementations, determining the skills includes determining dynamic skills from text fields from the plurality of fields using the clustering algorithm. The computer-implemented method may further include generating sub-skills from the text fields and updating the taxonomy with the sub-skills.

In another general aspect, a computer program product for intelligent skills matching is tangibly embodied on a non-transitory computer-readable medium and includes executable code that, when executed, is configured to cause a data processing apparatus to receive a plurality of tickets, where each ticket in the plurality of tickets includes a plurality of fields and at least one agent that resolved the ticket. The data processing apparatus determines skills from the plurality of tickets using a clustering algorithm on one or more of the plurality of fields, generates a taxonomy of the skills using a taxonomy construction algorithm, and creates and outputs a skills matrix or a skills knowledge graph using the taxonomy of the skills with agents connected to the skills.

In another general aspect, a system for intelligent skills matching includes at least one processor and a non-transitory computer-readable medium including instructions that, when executed by the at least one processor, cause the system to implement an application that is programmed to receive a plurality of tickets, where each ticket in the plurality of tickets includes a plurality of fields and at least one agent that resolved the ticket. The application is programmed to determine skills from the plurality of tickets using a clustering algorithm on one or more of the plurality of fields and generate a taxonomy of the skills using a taxonomy construction algorithm. The application is programmed to create and output a skills matrix or a skills knowledge graph using the taxonomy of the skills with agents connected to the skills.

Implementations for the computer program product and the system may include one or more of the features described above with respect to the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for intelligent-skills learning.

FIG. 2A is an example table of product name field skills.

FIGS. 2B and 2C are example tables of operational category skills.

FIG. 3 is an example of a hierarchical skill with a containment relationship.

FIG. 4 is an example of a hierarchical skill path for both static skills and dynamic skills without agents.

FIG. 5 is an example of a hierarchical skill path for both static skills and dynamic skills with agents.

FIG. 6 is an example skills knowledge graph illustrating skills and agent associated with the skills.

FIG. 7 in an example graph for inbound tickets and outbound tickets.

FIG. 8 is an example process for intelligent skills matching to an agent.

FIG. 9 is an example process for hierarchical skills matching to an agent.

FIG. 10 is a table illustrating a skill and agent scoring for the skill.

FIGS. 11A and 11B is an example flowchart illustrating example operations of the system of FIG. 1.

### DETAILED DESCRIPTION

This document describes systems and techniques for automated skill discovery, skill level computation, and intelligent matching using generated hierarchical skill paths. The systems and techniques use machine learning (ML) and/or artificial intelligence (AI) techniques to identify a hierarchy of skills from a historical database of artifacts. The automatically generated hierarchy of skills may be laid onto a knowledge graph. In this manner, a taxonomy of skills is autogenerated using ML and/or AI techniques from a database of artifacts. Additionally, the skills for each person interacting with the artifacts are determined and a skill level is computed using statistical computational techniques for each person and a skills matrix and/or skills knowledge graph is generated. In response to receiving a new artifact, the system uses an automated search using the skills matrix and/or the skills knowledge graph to find a person with skills appropriate for handling the new artifact. The new artifact may be automatically routed to a person with requisite skills to handle the artifact. The skills matrix and/or the skill knowledge graph learns and is updated with each new interaction between a person and an artifact.

In a similar manner, the automated search may be used as an expert locator to intelligently assemble a team of experts having various needed skills to handle a major incident. The system also may be used for skills gap training to identify areas where an agent or agents would benefit from additional training and to identify areas where an organization is lacking skilled agents. Finally, the system may be used to identify agents with requisite skills to author knowledge articles using their skill knowledge.

In one example of use of the system described in this document, the artifact is an ITSM ticket and the taxonomy and skills matrix and/or skills knowledge graph is automatically determined from historical tickets. An ITSM ticket may be a support request from one of multiple different channels related to one or more various aspects of an organization. An ITSM ticket is a digital record of an IT incident or event that includes relevant information about what happened, who raised the issue, and what has been done to resolve it. Incoming tickets may then be routed to an agent with the appropriate skills by performing an intelligent matching of the new tickets against the skills matrix and/or skills knowledge graph to find the appropriate agent(s) to assign automatically to handle the ticket. In another example use context, the skills matrix and/or the skills knowledge graph may be used to locate one or more experts to form a team for a major IT incident such as an outage. In other example use contexts, the artifact may be incidents, cases, work orders, etc.

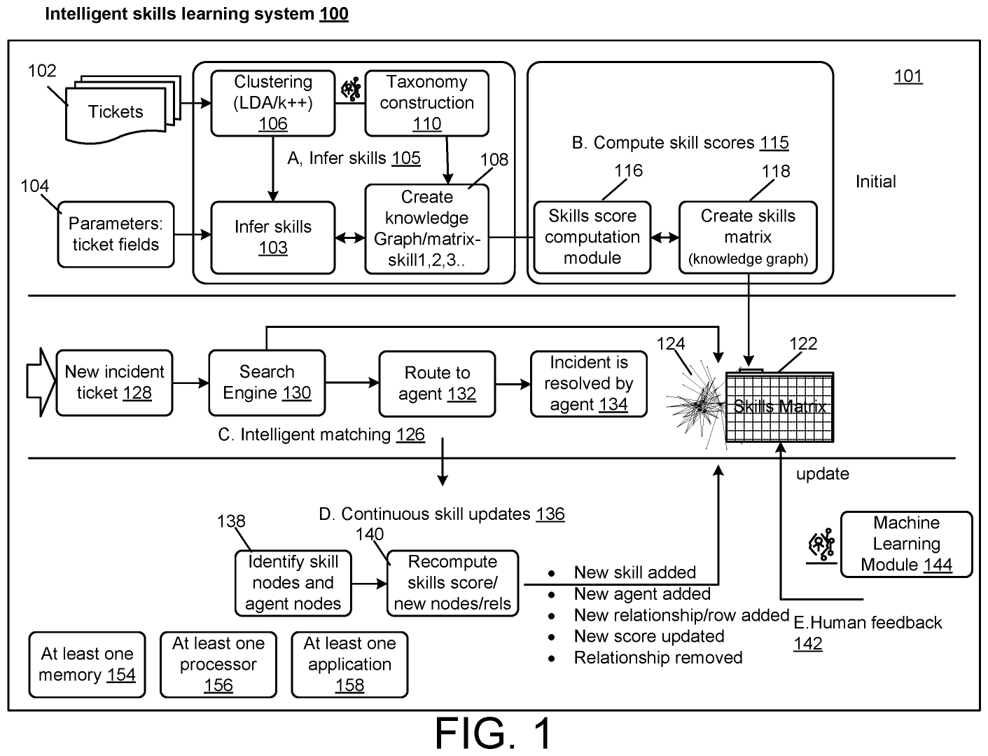

FIG. 1 is a block diagram of an intelligent skills learning system 100 (also referred to interchangeably throughout as the system 100). The system 100 may be applied to any type of artifact and the skills related to the artifact. As mentioned above, one example context use is where the artifact is an ITSM ticket (or simply ticket) and the skills are in the context of handling and resolving tickets.

The system 100 may be implemented on a computing device 101. The computing device 101 includes at least one memory 154, at least one processor 156, and at least one application 158. The computing device 101 may communicate with one or more other computing devices over a network (not shown). The computing device 101 may be implemented as a server (e.g., an application server), a desktop computer, a laptop computer, a mobile device such as a tablet device or mobile phone device, a mainframe, as well as other types of computing devices. Although a single computing device 101 is illustrated, the computing device 101 may be representative of multiple computing devices in communication with one another, such as multiple servers in communication with one another being utilized to perform the various functions and processes of the system 100 over a network. In some implementations, the computing device 101 may be representative of multiple virtual machines in communication with one another in a virtual server environment. In some implementations, the computing device 101 may be representative of one or more mainframe computing devices.

The at least one processor 156 may represent two or more processors on the computing device 101 executing in parallel and utilizing corresponding instructions stored using the at least one memory 154. The at least one processor 156 may include at least one graphics processing unit (GPU) and/or central processing unit (CPU). The at least one memory 154 represents a non-transitory computer-readable storage medium. Of course, similarly, the at least one memory 154 may represent one or more different types of memory utilized by the computing device 101. In addition to storing instructions, which allow the at least one processor 156 to implement an application 158 and its various components, the at least one memory 154 may be used to store data, such as clusters of tickets and outputs of the system 100, and other data and information used by and/or generated by the application 158 and the components used by application 158. The application 158 may include the various modules and components for the system 100 on the computing device 101, as discussed below. The application 158 may be accessed directly by a user of the computing device 101. In some implementations, the application 158 may be running on the computing device 101 as a component of a cloud network, where a user accesses the application 158 from another computer device over a network.

As agents resolve a variety of tickets, the system 100 analyzes the text and types of tickets the agent has resolved as well as the feedback and quality of the resolution and uses this knowledge of historical ticket descriptions and resolutions to build an AI/ML model that can learn agent skills automatically. How well the ticket got resolved in terms of time to resolve (MTTR), quality of resolution (e.g., no kick-backs, no transfers to other agents, etc.) and explicit feedback, all shape the skill level of the agent and is automatically determined through AI/ML techniques. The system 100 builds a skills agent knowledge graph that is created and continuously updated as new tickets get resolved. The process flow for the system 100 is illustrated in FIG. 1.

In Step A 105, the system 100 uses multiple tickets 102 and parameters from the ticket fields 104 to infer skills 103 of agents who worked on the tickets 102. In some implementations, a clustering algorithm 106 may be used to perform topic modelling clustering on the tickets 102 to infer skills 103 of agents. There are three ways skills can be inferred from structured and unstructured parts of the tickets that each agent resolves:
1. Static skills from categorical fields
2. Qualification-based skills
3. Dynamic skills from text fields

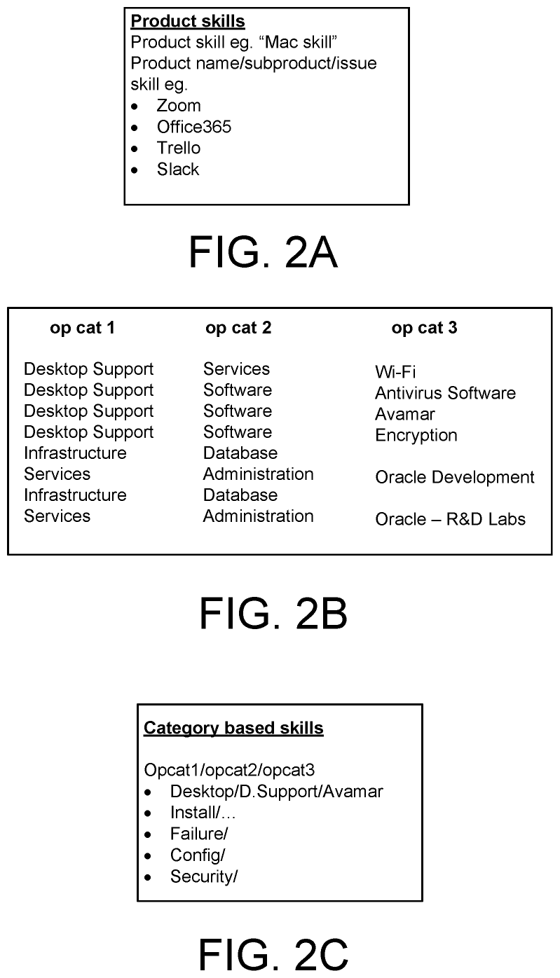

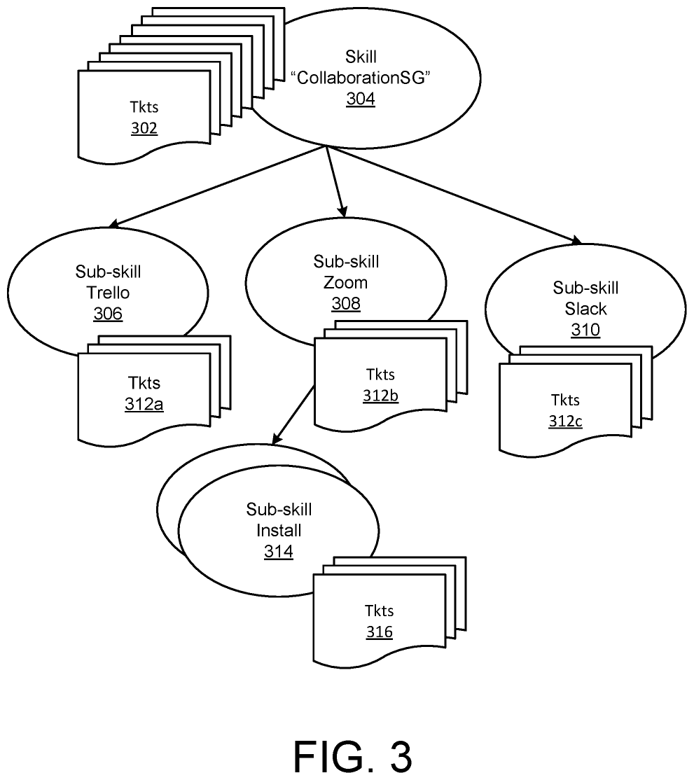

Referring to FIGS. 2A-2C, field-based skills are illustrated.

In a “ticket” one or more fields can be configured for skills tracking. All the values for these fields are taken into consideration as potential skills that need to be tracked. A skill definition includes skill definition name and list of field names to identify. Users can specify multiple skill definitions.

Product name field skills are illustrated in FIG. 2A. For example, Mac, Zoom, Office 365, Trello, Slack, etc. may be inferred from the field “Product Name” in the incident and are tracked as skills. Product name field skills include hierarchical skills as well when multiple fields are specified such as product, subproduct and issue.

FIGS. 2B and 2C illustrate operational category skills. Another example of hierarchical skills includes operational category tiers. For example, Operational Category Tier 1, Operational Category Tier 2, and Operational Category Tier 3 are fields where each combination forms a “skill” such as “Desktop Support#Services#Antivirus Software”, or “InfrastructureServices#DatabaseAdministration#Oracle—R&D Labs” or more.

Tickets 102 also include qualification-based skills. When a query is used to specify a skill, a set of incidents are identified that represents the skill. For example, a “major incident” skill can be defined as a set of incidents which have Major Incident flag=True.
Major Incident skill: “all incidents where M.I. field value =True”

Another example of a qualification-based skill is when an agent specifies “I am good at DB servers.” The agent statement can be converted into a search string and queried to retrieve the list of tickets.

Dynamic skills also may be inferred from tickets 102, where text fields are used to generate dynamic skills. These can be combined with a field-based skill or a standalone skill. The clustering algorithm 106 may be run on ticket data to generate a set of “topics” that groups similar tickets together. These form a dynamic skill that agents are resolving. In some implementations, the machine learning clustering algorithms 106 may include topic modelling algorithms such as Latent Dirichlet Allocation (LDA) or k-means clustering and can be run periodically or in real-time.

For example, if a company just released a new product “Webex”, and tickets start flowing in for such as “Cannot connect to webex”, “webex fails to install”, “webex voice call issues”, these are dynamic skills that are automatically added using the clustering algorithm 106.

In another example, topics that are generated can be for new services such as “address proof letter” cluster of tickets that just formed in recent weeks due to an increase request by employees. This is also another example of a dynamic skill.

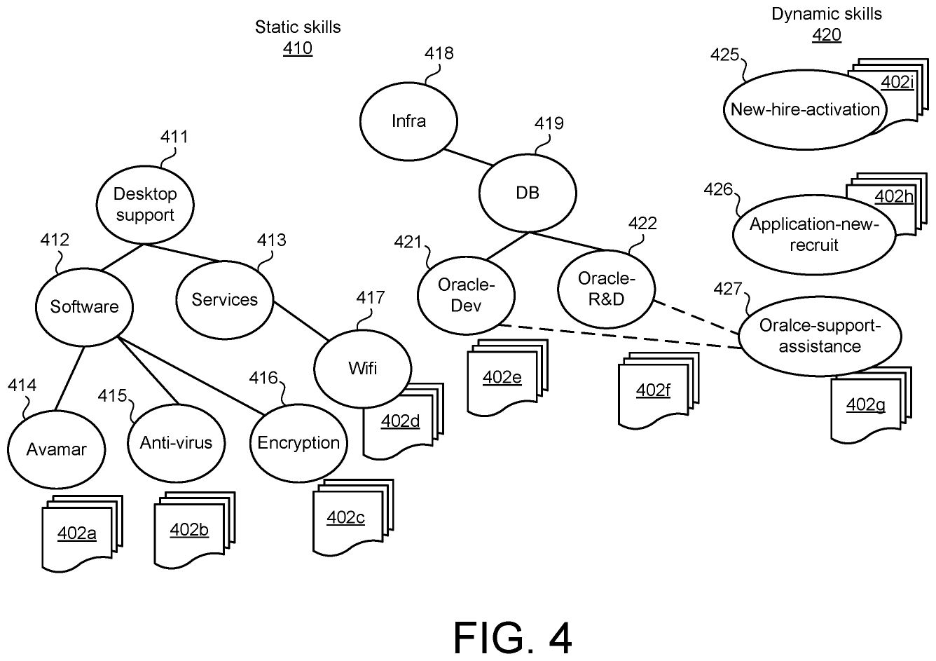

Finally, once the skills are all identified, they are laid onto a create knowledge graph/matrix-skill 108. In this step, the system 100 builds a create knowledge graph/matrix-skill 108 that includes skill nodes and agent nodes. For each static and dynamic skill output from the clustering algorithm 106, a node in the graph is generated. For each agent, a node in the graph is generated. When the skill is based on a hierarchical field specification such as (Opcat1, Opcat2, Opcat3) or (SG, Service) tuples, then the corresponding skill nodes with a containment relationship are used as shown in FIG. 3.

In the example of FIG. 3, the tickets 302 processed by the clustering algorithm 106 to infer the higher level skill “CollaborationSG” 304. The “CollaborationSG” skill 304 includes multiple sub-skills 306, 308, and 310 that are in a containment relationship with the “CollaborationSG” 304 skill. The sub-skills 306, 308, and 310 are each inferred from a respective portion of the tickets 312a, 312b, and 312c that are from the multiple tickets 302. Further the sub-skill 308 has a further sub-skill 314 that is in a container relationship with sub-skill 308. The sub-skill 314 is inferred from a portion of tickets 316 that is from the tickets 312b.

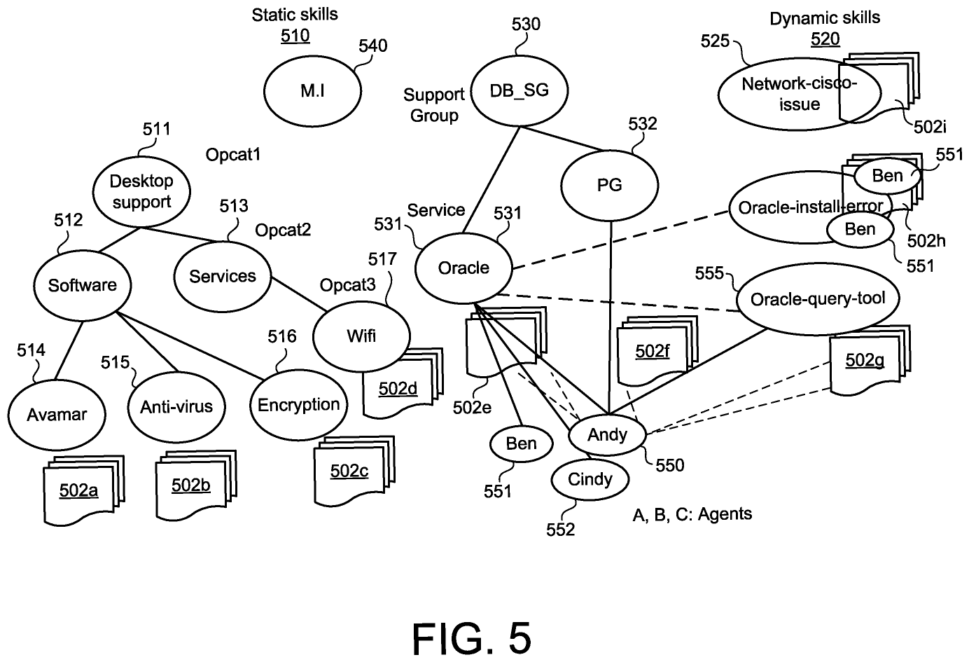

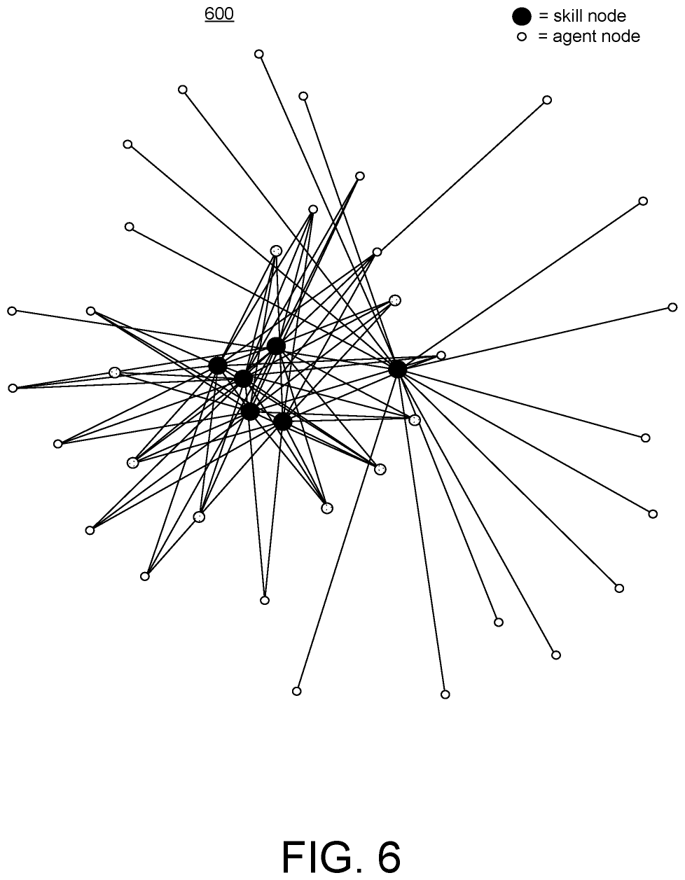

Referring to FIGS. 4 and 5, both static skills 410 and 510 and dynamic skills 420 and 520 generated by clustering tickets are illustrated. As discussed above, the static skills 410 and 510 are generated from categorical fields on tickets. In FIG. 5, the static skills 510 are also indicated as major incident (M.I.) skills 540, as discussed above. The static skills 410 and 510 are illustrated as skill nodes in a hierarchical relationship with a more general skill node, such as desktop support 411 and 511, infra 418, and support group DB_SG 530, at the top of the hierarchy of skills. Sub-skills, such as software 412 and 512 and services 413 and 513, are child nodes to parent node, desktop support 411 and 511. Sub-skills related to database administration DB 419 is a child node to the infrastructure services node, infra 418. Sub-skills, such as Oracle 531 and PG 532, are child nodes to DB_SG 530. Similarly, further specific sub-skills, such as Avamar 414 and 514, anti-virus 415 and 515, encryption 416 and 516, and wifi 417 and 517, are child nodes to the software 412 and 512 and services 413 and 513 nodes, respectively. Other specific sub-skills, such as skills in Oracle, Oracle-Dev 421 and Oracle R&D 422, are child nodes to DB 419. Note that each skill node has an associated set of tickets 402a-402i and 502a-502i with it.

In FIG. 4, the dynamic skills 420 do not identify the agent. In FIG. 5, the dynamic skills 520 includes the identification of the agent. In both, each represented skill node includes a cluster of tickets. For example, a new-hire-activation skill 425 includes a cluster of tickets 402i. Similarly, an application-new-recruit skill 426 includes a cluster of tickets 402h. Likewise, network-cisco-issue skill 525 includes a cluster of tickets 502i. In FIG. 5, note that each skill node has an associated set of tickets associated with it and each of the tickets has an agent who resolved the ticket associated with it. Agents Andy 550, Ben 551, and Cindy 552 are associated with the tickets each handled and resolved. Skill nodes may be de-duplicated when there are multiple skills that are similar. In some implementations, using a word2vec-trained natural language processing technique on the corpus or language model embeddings to learn word associations can provide a threshold-driven similarity to identify and de-duplicate skills.

Referring back to FIG. 1, a taxonomy construction algorithm 110 may be run that takes terms from each of the above static and dynamic skills, and generates embeddings from them in a space that can be latent, and clusters them together to find similar skills that need to be grouped or related to each other. In the example of FIG. 4, Oracle-support-assistance 427 will get linked to Oracle-Dev skill 421 and Oracle-R&D skill 422. The taxonomy construction algorithm 110 can regroup and relate these skills. For each skill identified, the taxonomy construction algorithm 110 identifies the set of tickets and associated agents who resolved the tickets for that skill cluster. In FIG. 5, Agent Andy 550 has resolved tickets in three types of skills clusters: Oracle 531, PG 532, and Oracle-query-tool 555. Hence, Agent Andy 550 node will have a relationship to each of these three skill nodes.

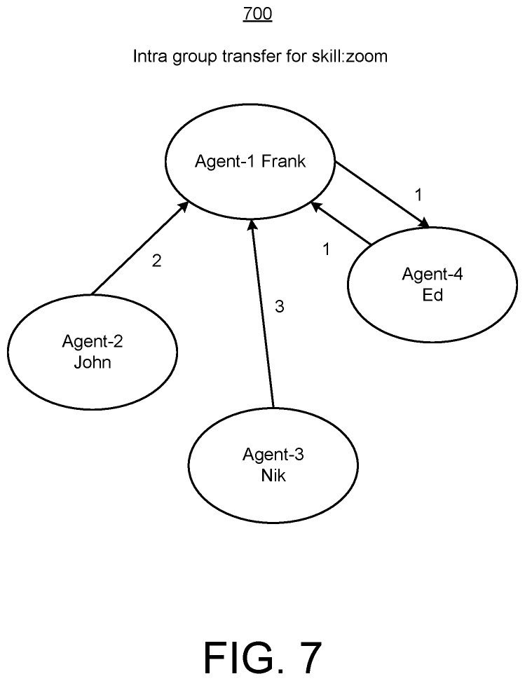

Referring to FIG. 6, an example skills knowledge graph 600 is illustrated. The skills knowledge graph 600, shown on FIG. 1 as 124, is the result of the create knowledge graph/matrix-skill 108 of FIG. 1. The skills knowledge graph 600 illustrates skills in the solid nodes and agents in the empty circle nodes. The relationship line connected between the agent node, the empty circle node, and the skill node, the solid node, indicate that the agent has resolved tickets for that skill node.

The next step in the system 100 is Step B compute skill scores 115, to compute the skill scores for each relationship between an agent and a skill. Once the relationships defined by the create knowledge graph/matrix-skill 108, the next step is to find out the strength of the relationship that defines how good is the agent in resolving the tickets of that skill by computing skills scores for agents using a skills score computation module 116. This results in the skill level for that agent. Agent metrics are used to define the skill level for each agent by combining multiple factors. In some implementations, the skills score computation module 116 uses statistics, centrality analysis, and regression analysis.

If the “purity” of the skills cluster has one agent who has resolved a high volume of cases, then this agent is clearly a skilled agent.

Each skill with a set of tickets has a MTTR for that skill cluster of tickets. Finding the ratio of agent's MTTR to skill's MTTR provides an indicator on how much better (or worse) the agent is compared to an agent population's average. If the resolved cases have high customer feedback (5***** rating) or have no escalations or no kickback or transfer counts, then the agent's skill level is considered high. All these metrics are combined for an agent to calculate the agent's skill score.

Each of these metrics will be normalized to a computed score that can be, for example, between 0 and 1 based on example specific formulae where 1 is higher skill while 0 is no skill. The following metrics may be used:
a Volume of tickets resolved by the ratio of agent to total tickets in the skill cluster, 1 means all tickets resolved by the agent
MTTR of tickets resolved by the ration of agent to MTTR of the skill cluster
Percentage of first day resolution
Call scores
Percentage of escalated tickets
Kickback Count
Transfer Count
Service Lifecycle Management (SLM) Status
Feedback
Sentiment analysis
Worklog—a sentiment analysis model may be used to indicate ‘which agents have the poorest sentiment scores’ in their interaction with customers.
   Specifically, a pre-trained bidirectional encoder representations from transformers (BERT) language model may be fine-tuned with a supervised task of classification, i.e., “Work log- and Sentiment Score” pairs, to build a log sentiment classifier.
Worklog—how to find who resolved the ticket from the words and statistical analysis of ticket data with multiple assignees.
   a Specifically, the pre-trained BERT language model may be fine-tuned with a supervised task of classification, i.e., “Work log-Ticket Resolver” pairs, to build a quality assurance (QA) system that understands the worklog and answers which agent solved the ticket.

In some implementations, the skills score computation module 116 uses the formula to calculate an agent skill score, where the agent skill score represents the proficiency of the agent at the skill, for example:

Skill score=W1*Volume_tickets_score+W2*Escalated_score+W3*Kickback_count_score+ . . .

Where W1, W2, . . . are weights that can be configured or learned through supervised learning to determine the weights automatically. Supervised learning can be used if the agent performance or skill scores are known and entered. If they are not, then an unsupervised weight-based approach will be used as indicated above to come up with final score. In the formula below, the w₁, w₂, . . . are the weights and xᵢ is a skill score between 0 and 1, such as x₁=“Volume_tickets_score”, x₂=“Escalated_score”, etc. as defined above.

$$x = \frac{{Σ}_{i = 1}^{n} ( {x}_{i} * {w}_{i} )}{{Σ}_{i = 1}^{n} {w}_{i}}$$

Aggregations can be done at various hierarchical levels of the skills ontology and a skills score can be computed at each level. For example, in FIG. 3, CollaborationSG 304 represents a broader concept of “Collaboration” with three sub-skills under it: Trello 306, Zoom 308, and Slack 310. Since each of theses sub-skills is associated with a set of tickets 312a-312c and agents who resolved the sub-skill, the same formulas can be used to generate a skills score at this sub-level. Hence, in FIG. 3, an agent will have a skills score at CollaborationSG 304, as well as at Trello 306, Zoom 308, and Slack 310.

Below are example ticket scoring formulas used to calculate the above-listed various metrics:

ResolvedTicketVolume_Score=resolved_ticket_count/total ticket count in a skill type

Kickback_score=−1*(kickback count/total resolved ticket count of an agent in a skill type)

Escalation_score=−1*(escalated_ticket_count/total resolved ticket count of an agent in a skill type)

Service level agreement (SLA or sla)_breach=#of times SLA breached (0 is good) or SLA warning generated or Within SLA.
sla_breach_score (or service lifecycle management (slm)) or slm_status_score)=This is a categorical feature with values such as No Service Target Assigned, Within the Service Target, Service Target Warning, Service Targets Breached, All Service Targets Breached. The score is calculated based on the purity of this categorical feature (mode value/number of tickets in a skill type).
For example: Below are the scores for each class of this feature—
score_by_slm_status_category[‘No Service Target Assigned’]=0
score_by_slm_status_category[‘Within the Service Target’]=1
score_by_slm_status_category[‘Service Target Warning’]=0.6
score_by_slm_status_category[‘Service Targets Breached’]=0.4
score_by_slm_status_category[‘All Service Targets Breached’]=0.2

When the agent resolves a maximum tickets with ‘Service Target Warning’ generated in a specific skill type, then his slm_status purity will be ‘Service Target Warning’ and sla_breach_score=0.6
FDR=number of times an incident has been resolved within 24 hours of its submission date (the more would be the better) (e.g., Within first day score=1 and Not within first day score=0)
fdr_score=The score will be calculated based on purity (mode value/no of tickets in a skill type) of this categorical feature in the specific skill type. When the agent resolves a maximum number of tickets within 24 hrs in a skill type; the agent's fdr purity will be ‘Within First day’, and the score will be 1.
TTR_Score=Time spent on ticket resolution in a specific skill type
TimeSpentHrs=LastResolvedDate−SubmitDate
Identify 4 buckets of TimeSpentHrs starting from minimum value of time spent and maximum value of time spent in a specific skill type
0-25% of time spent hours (score=1), 25% to 50% of time spent hours (0.6), 50% to 75% of time spent hours (score=0.4) and 75% to max time spent hours (score=0.2)
Identify a bucket to which a maximum number of incidents resolved by an agent in a specific category belongs.
Each bucket has a score that becomes the agent's time to resolution (TTR) of a specific sill type in the skill score computation, TTR_Score.

The ticket-scoring formulas are evaluated at each skill node and a score is assigned to agents who have resolved tickets with that skill. In some implementations, these formulas may be configured and can be active or inactive as set by a user or administrator of the system.

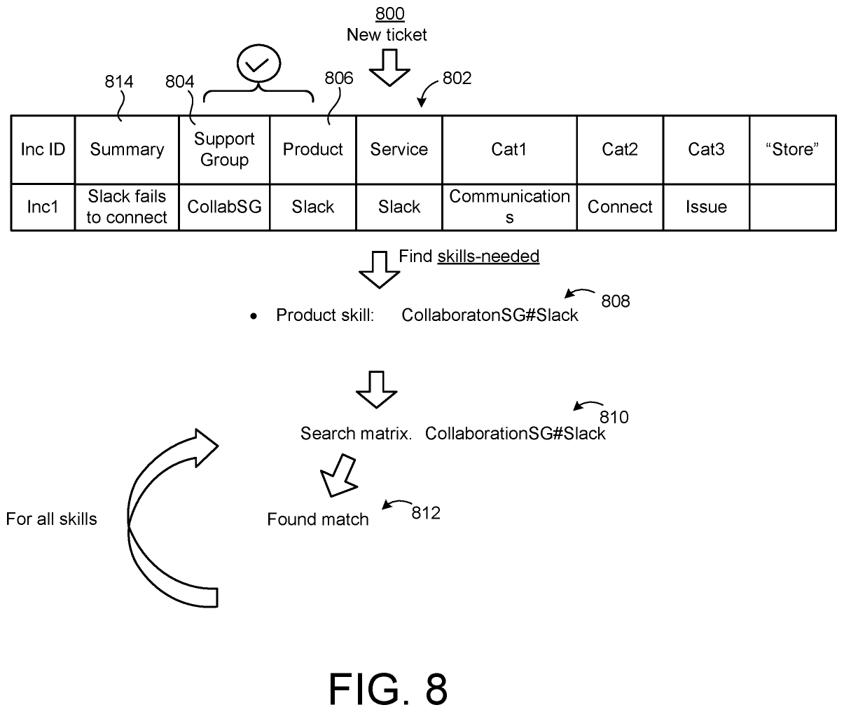

The skills score computation module 116 also may use other parameters in addition to the metrics above to compute the skills score for an agent. Referring to FIG. 7, another parameter that may be used is the number of outbound to the number of inbound ticket ratio. FIG. 7 illustrates a graph 700 showing numbers of inbound tickets and outbound tickets transferred between agents as directional arrows between agent nodes. This may be calculated on a per skill basis. The higher this ratio, the lower the skill, indicating that a higher number of these types of tickets are getting transferred from one agent to another. 1-the ratio of (number of outbound to number of inbound tickets) denotes the factor, where, for example, a value of 1 implies there are 0 outbound to inbound tickets being transferred and hence the agent is highly skilled.

The skills score computation module 116 calculates the scores for the agents and a skills matrix and the create skills matrix (knowledge graph) 118 is created. The skills matrix 122 and/or skills knowledge graph 124 is used in the intelligent matching 126 of the system 100.

Step C in the system 100 is intelligent matching 126 using the skills matrix 122 and/or the skills knowledge graph 124. As new tickets are created, the skills needed to resolve the ticket are determined based on the skills definitions. In one example, single skill matching is determined. For static skills, the fields specified in the new incident ticket 128 definition are used by search engine 130 to look for those skills in the skills matrix122 and/or the skills knowledge graph 124.

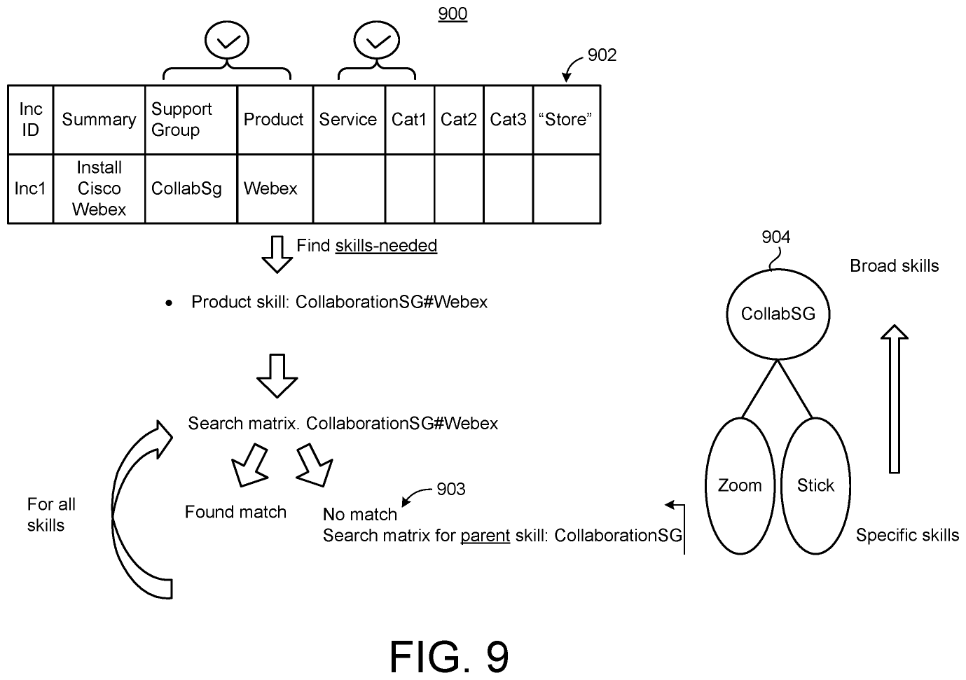

FIG. 8 illustrates an example process 800 for receiving a new ticket and searching for an agent with the necessary skills. For example, process 800 includes receiving a new ticket 802. The ticket 802 includes multiple fields and the search for single skill matching may key off of the “Support Group” field 804 and the “Product” field 806. If this skill definition is “Support group, Product” field 804 and 806, then the skill needed for this ticket resolution is “CollaborationSG#Slack” 808. The search engine 130 uses the skill definition to search 810 the skills matrix 122 and/or the skills knowledge graph 124 to find the best agents with the highest skill score 812. In FIG. 1, the search engine 130 finds the agent with the highest skill score and routes the ticket to the agent 132. The incident is then resolved by the agent 134.

For dynamic skills in the ticket, the search engine 130 computes the ticket's distance from dynamic skill nodes to determine which skill node it belongs to using, for example, cosine similarity, which is the measure of similarity between two non-zero vectors of an inner product space. For example, in FIG. 8, assume that slack has 4 subskills, each with clusters formed during skill inference: [connect-issue-slack][install-stack-fails][video-issues][audio-cannot]. As this new ticket has a text field “Slack fails to connect” 814, it will match with the [connect-issue-slack] cluster as this will have the smallest Euclidean distance between the ‘ticket’ and ‘subskills’

For multiple skills matching when multiple skills are specified, then the search engine 130 performs a search for each skill and then a weighted average is taken of the scores for each skill.

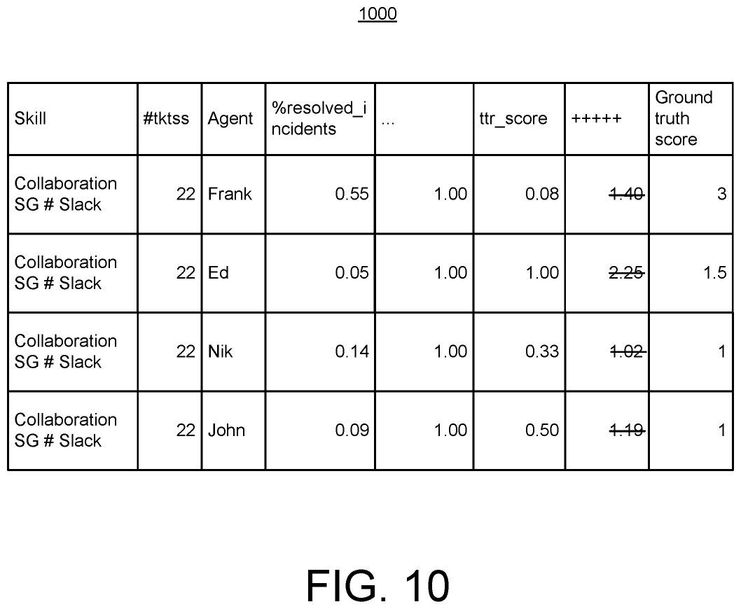

The search engine 130 also may perform hierarchical skill matching. For example, when a skill fails to match, as shown in the example process 900 of FIG. 9, where a skill “CollaborationSG#Webex” for a ticket 902 is not found in the skills matrix 122 or in the skills knowledge graph 903 (124 in FIG. 1). When there is no match, the search engine 130 performs hierarchical skill matching. In this case, the parent node “CollaborationSG” 904 is searched by the search engine 130 for the agent to get a score. Also, the skill score is reduced by a configurable factor (e.g., 0.8) to indicate that the skill is not truly a specific skill in Webex, but it is a broad skill—“CollaborationSG”. This process of searching for a parent node of the skill continues until a match is found.

Step D in the system 100 is continuous skill updates 136. That is, the skills matrix 122 and/or the skills knowledge graph 124 is updated continuously with each ticket received and resolved by an agent. First, using intelligent matching 126, an identify skill nodes and agent nodes 138 process is implemented within the tickets.

As agents resolve tickets, the skill score is re-computed and the skills matrix 122 and/or the skills knowledge graph 124 are kept updated as a recompute skills score/new nodes/rels 140 step. Multiple methods can be used to do this either on a batch process that is run on a schedule or in real-time as soon as the incident is resolved. This can involve multiple scenarios such as:
New skill added
New agent added
New relationship/row added
New score updated
Relationship removed

Step E in the system 100 is human feedback 142.

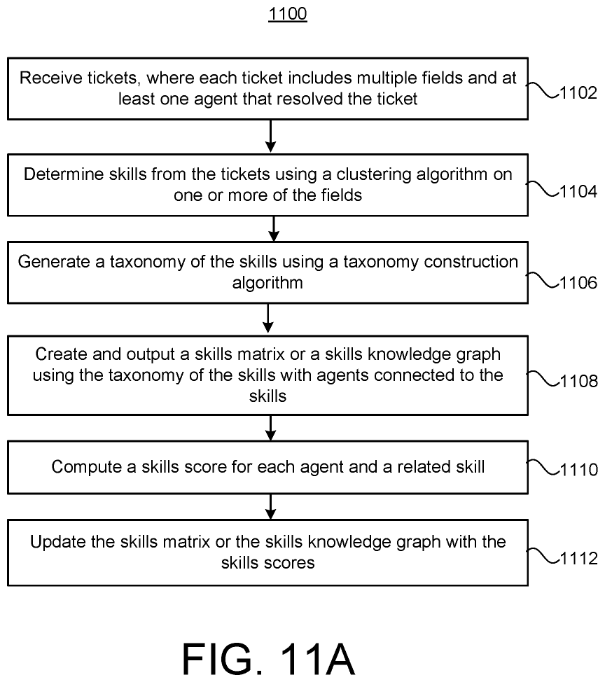

Humans can provide feedback on how the agents are performing so that the algorithm can improve over time. As shown in table 1000 of FIG. 10, when agents are scored by a human and ranked on who did better than other agents (let's say on the scale of 0 to 1), we can represent it as a “Ground truth score”. This ground truth score can then be used to learn the weight embeddings (w1, w2, w3 . . . ) by training a machine learning module 144 with L2 loss (regression, Neural Network, support vector machine (SVM) learning, etc.). These weight embeddings when learned in a supervised manner with human feedback scores as the ground truth score, will provide accurate skill scores for every agent. Re-training of weight embeddings networks also reveals the importance of different skill score categories and their changing significance over periods of time.

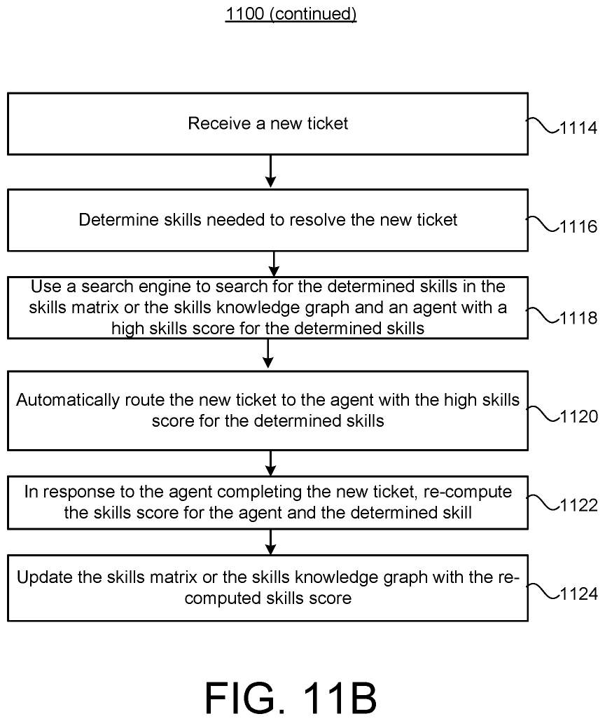

FIGS. 11A and 11B is an example flowchart for a process 1100 illustrating example operations of the system 100 of FIG. 1. More specifically, process 1100 illustrates an example of a computer-implemented method for intelligent skills matching. The result of the process 1100 may include an output to a graphical user interface (GUI) that may be implemented by the at least one application 158 of FIG. 1. Process 1100 provides an automated ticket routing mechanism that automatically routes the ticket, without user or human intervention, to an agent or agent(s) having the skills called for in the ticket, where the agent's skills are derived from previous tickets that they resolve.

Instructions for the performance of the process 1100 may be stored in the at least one memory 154 of FIG. 1, and the stored instructions may be executed by the at least one processor 156 of FIG. 1 on the computing device 101. Additionally, the execution of the stored instructions may cause the at least one processor 156 to implement the at least one application 158 and its components.

In FIG. 11A, process 1100 includes receiving tickets, where each ticket includes multiple fields and at least one agent that resolved the ticket (1102). Process 1100 includes determining skills from the tickets using a clustering algorithm on one or more of the fields (1104). Process 1100 includes generating a taxonomy of the skills using a taxonomy construction algorithm (1106). Process 1100 includes creating and outputting a skills matrix or a skills knowledge graph using the taxonomy of the skills with agents connected to the skills (1108). Process 1100 further includes computing a skills score for each agent and a related skill (1110) and updating the skills matrix or the skills knowledge graph with the skills score (1112).

In FIG. 11B, process 1100 continues and includes receiving a new ticket (1114) and determining skills needed to resolve the new ticket (1116). Process 1100 includes using a search engine to search for the determined skills in the skills matrix or the skills knowledge graph and an agent with a high skills score for the determined skills (1118) and automatically routing the new ticket to an agent with a high skills score for the determined skills (1120). Process 1100 includes, in response to the agent completing the new ticket, re-computing the skills score for the agent and the determined skill (1122) and updating the skills matrix or the skills knowledge graph with the re-computed skills score (1124).

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for intelligent skills matching, the method comprising:
receiving a plurality of tickets, wherein each ticket in the plurality of tickets includes a plurality of fields and at least one agent that resolved the ticket;
determining skills from the plurality of tickets using a clustering algorithm on one or more of the plurality of fields;
generating a taxonomy of the skills using a taxonomy construction algorithm; and
creating and outputting a skills matrix or a skills knowledge graph using the taxonomy of the skills with agents connected to the skills.

2. The computer-implemented method as in claim 1, further comprising:
computing a skills score for each agent and a related skill; and
updating the skills matrix or the skills knowledge graph with the skills score.

3. The computer-implemented method as in claim 2, further comprising:
receiving a new ticket;
determining skills needed to resolve the new ticket;
using a search engine to search for the determined skills in the skills matrix or the skills knowledge graph and an agent with a high skills score for the determined skills;
and automatically routing the new ticket to the agent with the high skills score for the determined skills.

4. The computer-implemented method as in claim 3, further comprising:
in response to the agent completing the new ticket, re-computing the skills score for the agent and the determined skills; and
updating the skills matrix of the skills knowledge graph with the re-computed skills score.

5. The computer-implemented method as in claim 1, wherein determining the skills includes determining static skills from category fields from the plurality of fields.

6. The computer-implemented method as in claim 1, wherein determining the skills includes determining dynamic skills from text fields from the plurality of fields using the clustering algorithm.

7. The computer-implemented method as in claim 6, further comprising:
generating sub-skills from the text fields; and
updating the taxonomy with the sub-skills.

8. A computer program product for intelligent skills matching, the computer program product being tangibly embodied on a non-transitory computer-readable medium and including executable code that, when executed, is configured to cause a data processing apparatus to:
receive a plurality of tickets, wherein each ticket in the plurality of tickets includes a plurality of fields and at least one agent that resolved the ticket;
determine skills from the plurality of tickets using a clustering algorithm on one or more of the plurality of fields;
generate a taxonomy of the skills using a taxonomy construction algorithm; and
create and output a skills matrix or a skills knowledge graph using the taxonomy of the skills with agents connected to the skills.

9. The computer program product of claim 8, further comprising executable code that, when executed, is configured to cause the data processing apparatus to:
compute a skills score for each agent and a related skill; and
update the skills matrix or the skills knowledge graph with the skills score.

10. The computer program product of claim 9, further comprising executable code that, when executed, is configured to cause the data processing apparatus to:
receive a new ticket;
determine skills needed to resolve the new ticket;
use a search engine to search for the determined skills in the skills matrix or the skills knowledge graph and an agent with a high skills score for the determined skills; and
automatically route the new ticket to the agent with the high skills score for the determined skills .

11. The computer program product of claim 10, further comprising executable code that, when executed, is configured to cause the data processing apparatus to:
in response to the agent completing the new ticket, re-compute the skills score for the agent and the determined skills; and
update the skills matrix of the skills knowledge graph with the re-computed skills score.

12. The computer program product of claim 8, wherein determining the skills includes determining static skills from category fields from the plurality of fields.

13. The computer program product of claim 8, wherein determining the skills includes determining dynamic skills from text fields from the plurality of fields using the clustering algorithm.

14. The computer program product of claim 13, further comprising executable code that, when executed, is configured to cause the data processing apparatus to:
generate sub-skills from the text fields; and
update the taxonomy with the sub-skills.

15. A system for intelligent skills matching, the system comprising:
at least one processor; and
a non-transitory computer-readable medium comprising instructions that, when executed by the at least one processor, cause the system to implement an application that is programmed to:
receive a plurality of tickets, wherein each ticket in the plurality of tickets includes a plurality of fields and at least one agent that resolved the ticket;
determine skills from the plurality of tickets using a clustering algorithm on one or more of the plurality of fields;
generate a taxonomy of the skills using a taxonomy construction algorithm; and
create and output a skills matrix or a skills knowledge graph using the taxonomy of the skills with agents connected to the skills.

16. The system of claim 15, wherein the application is further programmed to:
compute a skills score for each agent and a related skill; and
update the skills matrix or the skills knowledge graph with the skills score.

17. The system of claim 16, wherein the application is further programmed to:
receive a new ticket;
determine skills needed to resolve the new ticket;
use a search engine to search for the determined skills in the skills matrix or the skills knowledge graph and an agent with a high skills score for the determined skills; and
automatically route the new ticket to the agent with the high skills score for the determined skills .

18. The system of claim 17, wherein the application is further programmed to:
in response to the agent completing the new ticket, re-compute the skills score for the agent and the determined skills; and
update the skills matrix of the skills knowledge graph with the re-computed skills score.

19. The system of claim 15, wherein determining the skills includes determining static skills from category fields from the plurality of fields.

20. The system of claim 15, wherein determining the skills includes determining dynamic skills from text fields from the plurality of fields using the clustering algorithm.

21. The system of claim 20, wherein the application is further programmed to:
generate sub-skills from the text fields; and
update the taxonomy with the sub-skills.
